(19) United States
(12) Patent Application Publication
(10) Pub. No.: US 2012/0203668 A1
(43) Pub. Date: Aug. 9, 2012

(54) METHOD AND SYSTEM FOR ALLOWING A USER TO INTERACT WITH THE INVENTORY OF A RETAIL LOCATION

(75) Inventors: Christopher Howard, Greenwich, CT (US); Robert Burke, Greenwich, CT (US)

(73) Assignee: Columbia Insurance Company, Omaha, NE (US)

(21) Appl. No.: 13/364,389

(22) Filed: Feb. 2, 2012

Related U.S. Application Data
(60) Provisional application No. 61/439,216, filed on Feb. 3, 2011.

(51) Int. Cl. G06Q 30/00

(52) U.S. Cl. 705/26.64

(57) ABSTRACT

The invention relates to a system allowing a customer in a retail location to interact with the inventory of said retail location, as well as a method of using said system. The system allows for searching, sorting, and viewing the inventory information through a user device, as well as requesting, purchasing, and reserving products for sale by said retail location.

### CROSS REFERENCE TO RELATED APPLICATIONS

This application claims priority to U.S. Provisional Patent Application Ser. No. 61/439,216 filed on Feb. 3, 2011. The contents of the above-identified Application is relied upon and incorporated herein by reference in its entirety.

### FIELD OF INVENTION

The invention relates to a system for allowing a user to interact with the inventory of a retail location and a method of using the same.

### BACKGROUND OF INVENTION

There is a need for shoe retailers to improve the shopping experience for their customers. The present method of a customer entering a store, searching the entire store for the shoe they desire, and then receiving the attention of the sales representative, whether that be to locate missing shoes or bring more examples of shoes from a back storeroom, is highly inefficient and may prove detrimental to successful sales interactions. A great number of customers are usually left unattended during this process simply because the sales representatives are looking for lost or missing shoes which may not even be in the store's inventory. Additionally, customers are often left alone while the sales representatives are looking for the shoes, which decreases face time with the customers and opportunities to sell other products.

What is desired, therefore, is a system and a method allowing sales representatives to interact more efficiently with customers in a brick and mortar retail location. Another desire is to increase face time between the customer and the sales representative id decrease time spent by the customer sifting through undesired merchandise or searching for desired merchandise currently unavailable at the retail location. Further, it is desirable to have customers engage in a more immersive shopping experience and give customers access to a greater amount of retail information in a more manageable way, enabling a customer to make more informed decisions in a more efficient manner.

### SUMMARY OF INVENTION

It is therefore an object of this invention to provide a system which allows a user to view and interact with the current inventory of a brick and mortar retail location and a method of using the same. It is a further object of the invention that a user of the system should be capable of searching and sorting the inventory of said brick and mortar location in order to view only those products which are of interest to them. It is also an object that a user should be provided suggestions to make them aware of other available products which do not match exactly the desired product's search criteria, but nevertheless exist as an adequate substitute in the event that user's desired product is unavailable. It is yet a further object of the invention to allow the user, after or while using the system, to purchase for immediate pickup, purchase of future pickup, or reserve for future purchase and pickup any product in the inventory of the brick and mortar location identified to the user through the use of the system of the instant invention.

One embodiment of the instant invention is a system allowing a user to interact with an inventory of a brick and mortar retail location. In this embodiment, the system comprises a computer and an inventory information database, said inventory information database having inventory information comprising at least one characteristic of at least one product sold at said brick and mortar retail location. The system further comprises a user device, software executing on said user device for accessing said database software executing on said user device for sorting said inventory information, and software executing on said user device for producing at least a first set of said at least one product to the user, wherein the products in said at least a first set have at least a first number of shared characteristics shared with each other and said second number of shared characteristics is greater than or equal to said first number of shared characteristics and said first number of shared characteristics is greater than said third number of shared characteristics. The system also comprises software executing on said user device for, based upon input from said user device, producing at least a second set of said at least one product to the user.

In another embodiment, the system further comprises software executing on said user device for, based upon input from said user device, producing a recommended product to the user, wherein said recommended product has at least a third number of shared characteristics shared with a product in said first set. An additional embodiment comprises software executing on said user device for purchasing at least one product. One embodiment of the system further comprises software executing on said user device for reserving at least one product, wherein said software executing on said user device for reserving at least one product further sends an alert to said user device regarding the location of said at least one product. In another embodiment, the system comprises software executing on said user device for performing an inspection action. In an additional embodiment, said inspection action is an alert sent to an employee of the brick and mortar retail location comprising inventory information about a product, wherein said alert further comprises location information of said user device.

A further embodiment of the instant invention is a brick and mortar inventory interaction method comprising the steps of providing a computer, providing an inventory information database on said computer, said inventory information database having inventory information comprising at least one entry defining at least one characteristic of at least one product sold at said brick and mortar retail location, providing an application having a user interface for interacting with said inventory information nation database, providing said application on a user device, said user device comprising a touch screen for navigating said user interface, sorting said inventory information using said application, generating at least a first set of said at least one product to a user, wherein the products in said at least a first set have at least a first number of shared characteristics shared with each other, generating at least a first subset of said at least one product to the user based on input from said user device, wherein the products in said at least a first subset set have at least a second number of shared characteristics shared with each other, said second number of shared characteristics being greater than or equal to said first number of shared characteristics, generating at least a first recommended product based on input from said user device and having at least a third number of shared characteristics less than said first number of shared characteristics with said first product. In another embodiment, the method includes the step of performing a selection action to inspect a selected product. In one embodiment, the method comprises the step of performing a purchasing action to purchase said selected product. In another embodiment said step of performing a purchasing action further comprises the step of performing a reservation action. In one embodiment, step of performing a reservation action comprises the step of providing said user a choice of holding said selected product at said brick and mortar retail location for pickup by said user or shipping said selected product to another location. In one embodiment, the step of sending an alert to said user device regarding a location of said selected product.

In one embodiment of the method of the instant invention, the method further comprises the step of performing an inspection action. In one embodiment, said inspection is an alert sent to an employee of the brick and mortar retail location comprising inventory information about a product. In another embodiment said alert further comprises location information of said user device.

In an additional embodiment, the instant invention is a system for allowing a user to interact with the inventory of a brick and mortar retail location comprising at least one system of a brick and mortar retail location comprising an inventory information database, wherein said inventory information comprises at least one characteristic of at least one product sold at said brick and mortar retail location, a user interface, an input device, a viewing device, an application on said input device capable of interacting with said inventory information, at least a first set of said at least one product displayed on said viewing device in response to at least a first input to said input device sharing at least a first number of characteristics, at least a second set of said at least one product displayed on said viewing device in response to at least a second input to said input device sharing at least a second number of characteristics, where said second set of said at least one product is a subset of said first set and a recommended product displayed on said viewing device in response to said first or second inputs to said input device sharing at least a third number of characteristics with said first set, wherein said second number of shared characteristics is greater than said first number of shared characteristics and said first number of shared characteristics is greater than said third number of shared characteristics.

### BRIEF DESCRIPTION OF FIGURES

The features of the invention believed to be novel and the elements characteristic of the invention are set forth with particularity in the claims. The figures are for illustration purposes only. The invention itself, however, both as to organization and method of operation, may be understood by reference to the detailed description which follows taken in conjunction with the accompanying drawings in which the drawings show typical embodiments of the invention and are not intended to be limited of its scope

FIG. 1 depicts a system for allowing a user to interact with the inventory of a brick and mortar retail location.

FIG. 2 depicts an embodiment of the system depicted in FIG. 1 further comprising a second set of search results.

FIG. 3 depicts an embodiment of the system depicted in FIG. 1 further comprising a recommended product and accompanying software.

FIG. 4 depicts an embodiment of the system depicted in FIG. 1 further comprising purchasing, inspecting, and reserving features and accompanying software.

FIG. 5 depicts a method of implementing the system depicted in FIG. 1 for allowing a user to interact with the inventory of a brick and mortar retail location.

FIG. 6 depicts an embodiment of the method depicted in FIG. 5 comprising a reservation function.

FIG. 7 depicts an embodiment of the method depicted in FIG. 6 comprising additional reservation function steps.

FIG. 8 depicts an embodiment of the method depicted in FIG. 5 comprising additional inspection action steps.

### DETAILED DESCRIPTION OF DRAWINGS

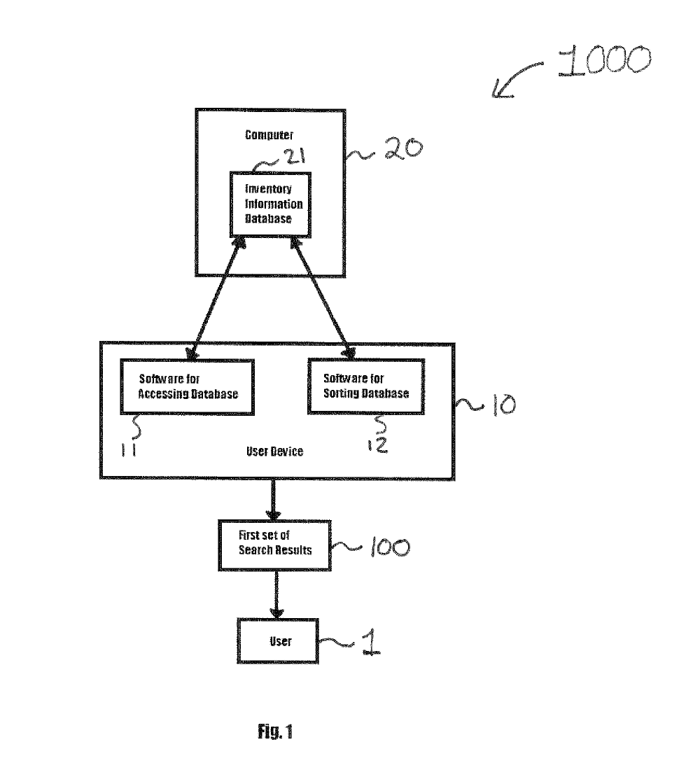

In describing the various embodiments of the instant invention, reference will be made herein to FIGS. 1-6 in which like numerals refer to like features of the invention.

FIG. 1 depicts one embodiment of the instant invention of providing a system 1000 allowing a user 1 to interact with the inventory of a brick and mortar retail location and search for a desired product. In this one embodiment, the system comprises a computer 20, or any electronic processing apparatus with a memory and a central processing unit (CPU). The specification and implementation of the computer are well within one of ordinary skill in the art, and are adapted to fit the specific brick and mortar retail location. In one embodiment for a large retail location, the system is likely to receive high user traffic and will require multiple servers with efficient processing and effective cooling systems in order to process the high volume of user requests received on any given day. Smaller operations may not require as sophisticated a system, as the load upon the system at any one time will require only a basic functional CPU and memory. The specific hardware components beyond the computer 20 required for system of the present invention are known to those of ordinary skill in the art and the specifications of those components are design features that may be tailored to the specific implementation of the system.

In one embodiment, the computer holds or accesses inventory information about the brick and mortar retail location. The inventory information is stored in any suitable location. In one embodiment, the inventory information is stored in a series of databases and spreadsheets 21 on the computer itself, for example on a memory such as a hard drive. In another embodiment, the inventory information is stored in a memory remote from the computer and downloaded in whole or in part upon request. The inventory information is shared in any suitable form. In one embodiment, the inventory information is compressed for more effective transfer of said information between the memory and an external location. In another embodiment, the inventory information is encrypted.

In one embodiment, the inventory information is a series of data entries detailing specific characteristics about a product for sale in a brick and mortar retail location. The characteristics of a product which are assigned data entries are not limited to a specific number or type of characteristics and depend on the business goals of the specific retail location. In one embodiment, the retail location is a footwear retailer, and therefore wishes to define the characteristics of the shoes in their inventory. Data entries define the shoes based upon their color, style, composition, size, manufacturer, manufacture origin, price location in the retail location, social statistics and characteristics, such as averaged user generated ratings and reviews and popularity statistics, and the like. The above-identified characteristics are non-limiting and the specific characteristics to be defined are well within one of ordinary skill in the art. In one embodiment, inventory information also includes a visual representation of the product, such as an image or a 3-dimensional model. The visual representation allows a user visually inspect a product to determine whether said product is the desired product.

The inventory information is accessible by a user using a user device 10. In one embodiment, the user device is provided to the user upon entry into the brick and mortar retail location, such as a mobile device owned by the retail location that the user receives upon entering the retail location and must return when leaving the retail location, or a non-mobile kiosk that the user has access to within the retail location. In another embodiment the user device is user's own device, such as their cell phone, tablet pc, and the like. In one embodiment, the user device has software for accessing the inventory information 11 and interacting with, for example sorting 12, said inventory information. In one embodiment, the software accesses the inventory information using a local area network. In another embodiment, the local area network allows the user to access the inventory information only when within or in close proximity to the brick and mortar retail location. In one embodiment, the software is accesses 11 and sorts 12 the inventory based on inputs from the user. In this embodiment, the user's involvement in the system is more active. The user device accesses the inventory information in response to a command from the user and the user inputs their intention to help the system guide their interactions with the system. For example, the user will open an application on a mobile device once inside a retail location and synchronize the inventory information of the retail location by executing synchronization software. The user then views the inventory information and sorts it however they wish. In another embodiment, the user device recognizes that it is has entered a retail location, begins an application for accessing the inventory information database of that retail location, and executing synchronization software without need for input from the user. In this embodiment, software also sorts the inventory information without input from the us for example as a default the inventory information may be sorted by price when initially displayed to the user or by proximity to the user's location. In another embodiment, the software for accessing the inventory information is executed either by input from the user or independent of the user.

The software granting the user access to the inventory information is an application having a user interface which allows the user to define the characteristics of a desired product. In one embodiment, the user interface is a graphic user interface which allows the user to define a desired product through interaction with a series of pictographic menus. While a user defines their desired product using the graphic user interface, the application is parsing the inventory information and retrieving a first set of the products entered into said database which share the characteristics defined by the user. The first set of products with a first number of shared characteristics is displayed to the user and the application further allows the user to view, manipulate, and sort the products of the first set.

In another embodiment, a user receives a first set 100 of products sharing a first number of characteristics from their inputs to the application and views the products on the user device. Application allows the user to view the potential desired products by displaying a list of the products in said first set. In one embodiment, the user sorts the first set by various characteristics as they compare and contrast the products of the first set to determine if any of said products are a product they wish to purchase. For example, a user wishes to see all blue, leather shoes made in Italy that are available a size 7 women's. The application returns a set with eight available styles matching those criteria to the user. The user then sorts the set according to price to view the results from greatest to least. In one embodiment, each product in a set of products returned in response to an inquiry from the user device is presented to the user as a series of “cards” displaying all the inventory information entered about said product. The user is allowed to view each product “card” individually or multiple “cards” at one time in any suitable combination.

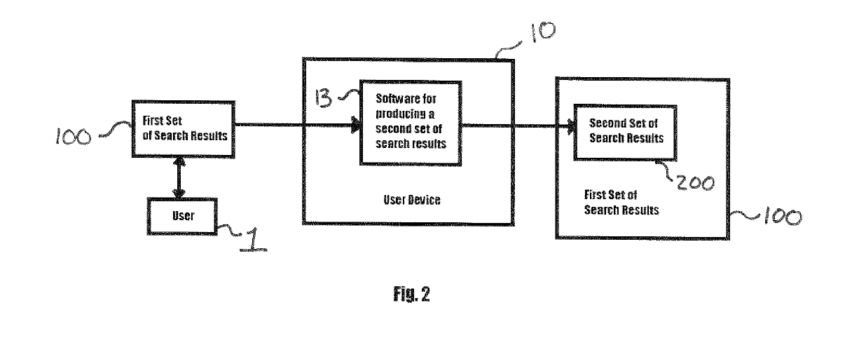

FIG. 2 depicts one embodiment of system 1000 wherein the user 1 determines that while the first set 100 includes all the products they wish to view, it also includes a certain type of product they have no desire to purchase. In one embodiment, the user device 10 comprises software 13 which allows a user to search just the first set 100 of products and return a subset of said first set of products, or a second set of search results 200. By limiting searches subsequent to the first search to first set of products, subsequent searches return results faster. The application is not taxed with parsing the entire product database in response to every user search request. Additionally, the process of searching the inventory is more user friendly. A user is able to eliminate undesired products from their search by creating a first set of desired products and then concern themselves solely with narrowing the remaining products. They are not burdened with trying to remember the search parameters they used to get to the set they are currently viewing. Further, by limiting subsequent searches only to the set currently displayed to the user, the effects of each search are more easily understood by the user. For example, a first set of search results is returned to a user comprising blue, Italian leather shoes in size 7 women's. The user then further searches the first set for shoes costing less than $50.00 and is able to see that the remaining shoes are often a lighter blue than is desired. This effect is immediately apparent to the user because the results of the first set and the subsequent set were displayed back to back and presented as related sets of data, rather than as two distinct snapshots of the whole database.

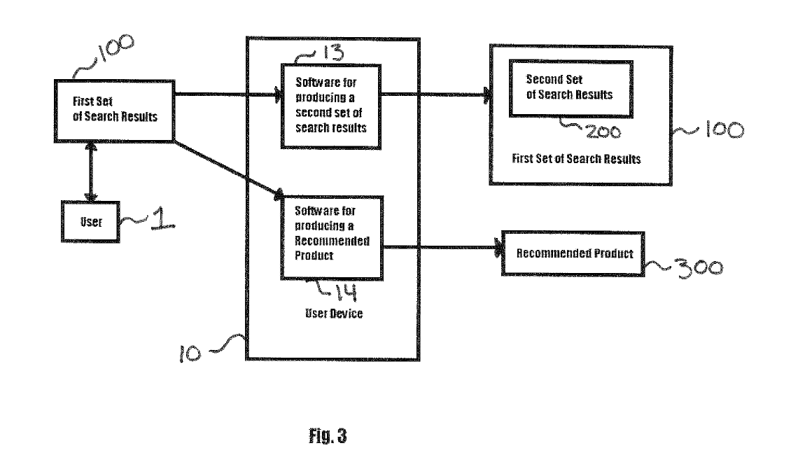

FIG. 3 depicts yet another embodiment of the system 1000 in FIG. 1, wherein the user device further comprises software 14 for providing the user 1 with a recommended product 300 having a third number of shared characteristics with the first set 100, In this embodiment, the recommended product 300 is separate from the first set 100 and in a further embodiment has characteristics other than those in the first set. For example, a first set of search results is returned to a user comprising blue, Italian leather shoes in a size 7 women's. The software 14 will additionally provide a recommended product 300 with a third number of shared characteristics that the user is interested in nonetheless, such as a blue leather shoe in size 7 women where the leather comes from the United States instead of Italy. If the first set of products provided to the user prove undesirable, the similarities between the products in the first set and the recommended product make the recommended product a reasonable substitute for certain users.

Sets and subsets of products are defined as having at least certain numbers of shared characteristics. When a set is generated for a user, the products in said set have at a number of shared characteristics equal to or greater the user defined characteristics of said set. For example, a search with three user defined characteristics will return a set of products that share at least those three user defined characteristics. Products which do not share those characteristics will be excluded from the first set. Second sets and subsets are defined to necessarily have more shared characteristics than the products in the first set. Recommended products, on the other hand, will have fewer shared characteristics as they lacked the required number of shared characteristics to be included in said first set.

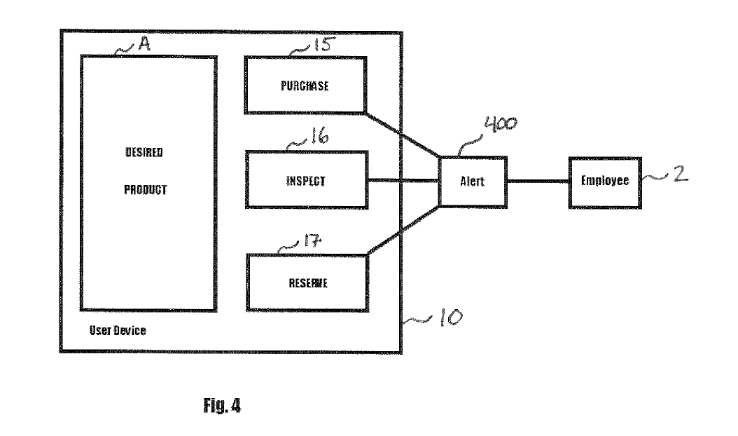

FIG. 4 depicts an embodiment of system 1000 which allows a user to conclude their shopping experience. The system comprises software allowing a user to perform an inspection action by activating inspection software 16. Once a user finds a desired product A using the user device 10, the user performs the inspection action. The inspection sends an alert 400 to an employee 2 at the retail location, the alert signifying that the user wishes to view the desired product A in person. In response to the alert, the employee fetches the product and brings the desired product A to the user. In one embodiment, the inspection software 16 is executed based upon input from the user or user device.

To facilitate the alert 400, in one embodiment the employee at the retail location has an employee device which receives and displays the alert 400 to the employee. The employee device is capable of collecting and organizing the inspection action alerts for the employee. Information displayed to the employee on the employee device in response to the alert 400 from inspection software 16 include, but are not limited to, all characteristics of the desired product stored in the database of inventory information, location of the product in a storeroom, location in the retail location of the user who performed the inspection action, and the like. Presented with the alert information, the employee is able to prioritize their responses to the alerts for more efficient user service, as well as finally bring the user n contact with an employee for more subjective analysis of the products. The employee also now has an opportunity to interact with the user to help close the sale.

In one embodiment, once the user finds a desired product, the user performs a purchasing action by activating purchasing software 15. The purchasing software 15 triggers the system to update the inventory information reduce the in stock value by the amount purchase. In one embodiment, purchasing software 15 causes an alert 400 to broadcast the commitment to purchase to a retail employee 2, who then fetches the desired product A from wherever the product is stored and bring the product to the user. In another embodiment, the desired product A is brought to the cash register. In this embodiment, desired products are stored at the cash register until the user is ready to check out. This method eliminates the need for the user to carry their desired products around the retail location as they search the retail location for other products they might wish to purchase. Once the user wishes to check out, they visit the cash register to pay for and receive the products, In one embodiment, the purchasing software 15 is executed based upon input from a user or a user device.

In one embodiment, the system comprises software 17 for performing a reservation action. In this embodiment, the user finds a desired product A for sale by the retail location, but the product is not immediately available for purchase. The reservation software 17 allows a user to reserve said desired product A for later pickup. In one embodiment, the reservation software 17 allows a user to order the desired product A and have the product shipped to the retail location for pickup at the retail location. In another embodiment, the user specifies where the product A should be shipped for later pickup, whether that be the retail location or any other address. In one embodiment, the system notifies the user through the user device when the desired product A has shipped to the specified location and when the desired product has arrived at that location. In another embodiment, the reservation software 17 is executed based upon input from the user or device.

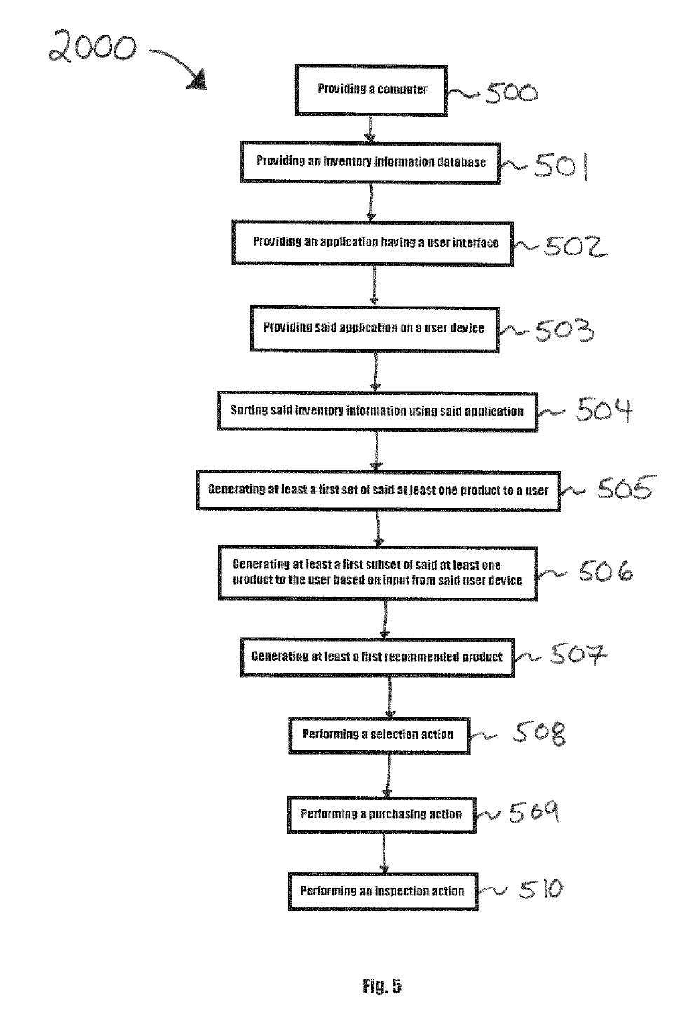

FIG. 5 depicts one embodiment a method 2000 of using the system of FIG. 1. The method 2000 comprises the step 500 of providing a computer and step 501 of providing an inventory information database. Further, the method 2000 comprises steps for 502 providing an application having a user interface and 503 providing said application on a user device. Using said user device and the application on said user device, the user sorts 504 the inventory information. In one embodiment, the sorting step includes any initial manipulation of the inventory information including searching or sorting of the information in the inventory. The method 2000 further comprises the step 505 of generating at least a first set of said at least one product to the user. In one embodiment, generation step 505 further includes steps for displaying the first set on a user device. In another embodiment, the first set is displayed to the user, as described above, as a series of product “cards” comprising all the defined characteristics from the inventory information database. The user is able to view one or multiple products at one time to determine if first set comprises products the user finds desirable.

In another embodiment, the method 2000 comprises the step 506 of generating a first subset of said at least a first set of at least one product. The first subset is generated in response to a search action of only the products that were isolated into said first set. This method eliminates the need to search the entire inventory database all over again to further o results for a user. The first subset will have a second number of shared characteristics, wherein the second set of shared characteristics is greater than said first set of shared characteristics.

In one embodiment, the method 2000 further comprises generating 507 a first recommended product. The recommended product has a third number of shared characteristics in common with said first set, and said third number of shared characteristics is less than said first number of shared characteristics. In another embodiment, the method generates a class of recommended products. In this embodiment, the application recognizes that a user is eliminating an entire genre of products through the stipulation of an unduly shared characteristic. The application offers a recommendation to the user to consider altering their search criteria to remove said unduly limiting search characteristic. In further embodiments, the system provides at least a second recommended item based on input from the user device. In another embodiment, the system provides a plurality of recommended items to the user based on input from the user device.

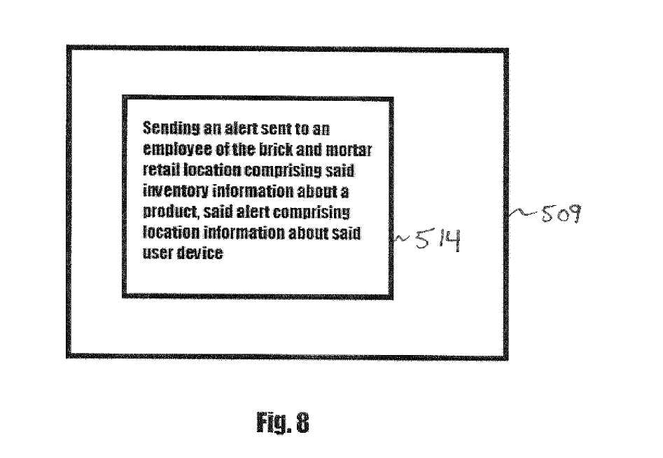

In another embodiment, the method 2000 comprises steps for concluding the user transaction: performing 508 a selection action, performing 509 a purchasing action, and performing 510 an inspection action. By performing 508 a selection action, the user narrows the set of products to one final product. The user may then view all available inventory information about said product. In one embodiment, the user is given a 3-dimensional representation of the product to view. The 3-dimensional representation is rotatable so that the user can view the product from any desired angle. In one embodiment, should the 3-dimensional representation be found insufficient to convey to the satisfaction of the user that the product is the desired product, the user performs 510 an inspection action, sending an alert to an employee of the retail location that they wish to inspect the product in person prior to making a purchase commitment. FIG. 8 depicts an embodiment where an alert is sent 514 as part of the purchasing action as well. The employee will bring the product in question to the user so that they may view the product in person and make the final determination of whether or not to purchase the item.

In one embodiment, the 3-dimensional representation is sufficient to convince the user that this is the desired product. The user then performs 509 a purchasing action. The purchasing action updates the inventory information database by reducing the amount of product stock by 1. Further, an alert is sent to an employee of the retail location to fetch the product for the user. In another embodiment, the user defines where the employee should take the product and where they would like to retrieve the product.

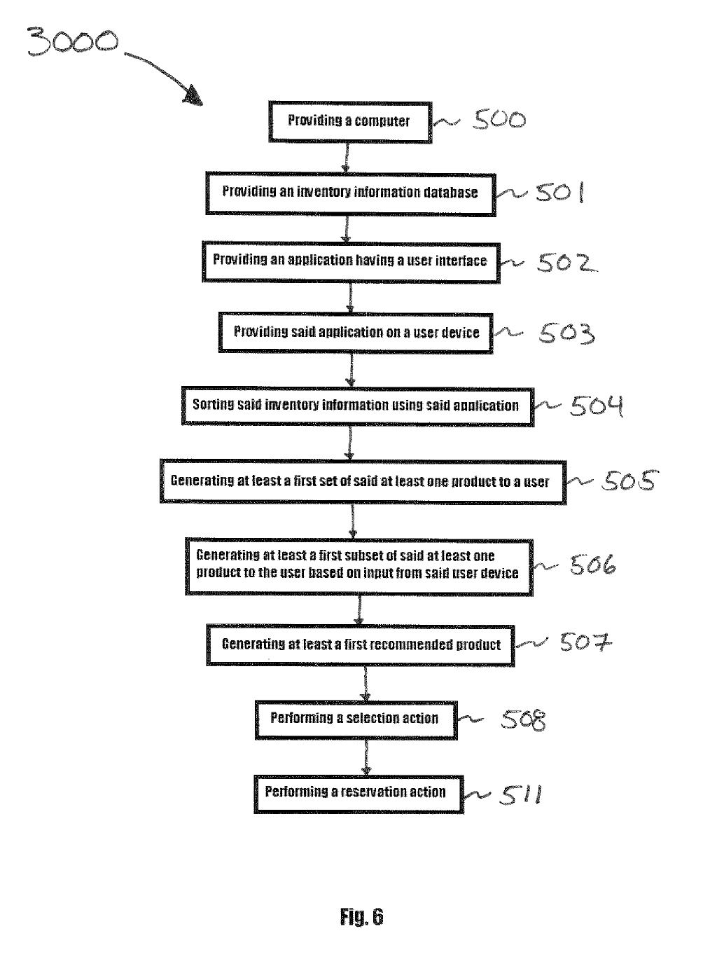

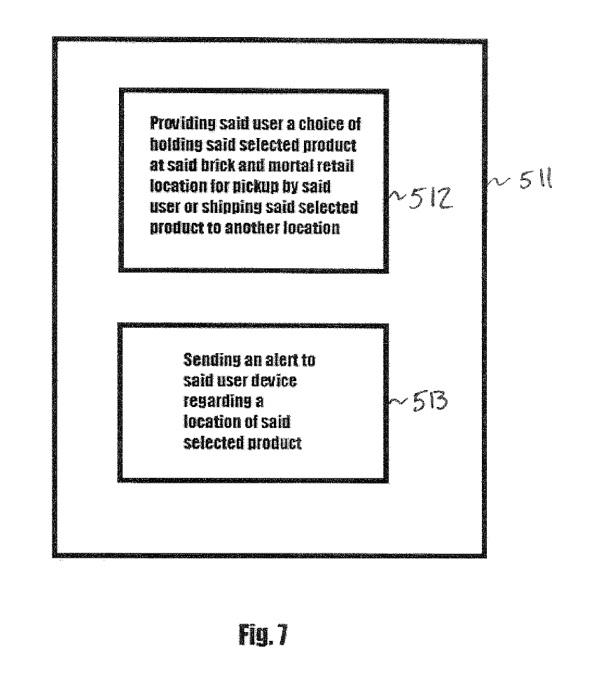

FIG. 6 depicts an embodiment of FIG. 5, method 3000, in which the user has found a desired product but cannot retrieve the product at the present time. In this embodiment, the user performs 511 a reservation action. In one embodiment, the desired product is present in the retail location but the user does not have the money on hand to purchase the product at that moment. The user performs 511 the reservation action and the product is held for a certain amount of time, allowing the user to retrieve the funds necessary to purchase the product and return without fear of another user purchasing the product in the meantime. In another embodiment, the desired product is not currently available for purchase. In this embodiment, the user performs 511 a reservation action to guarantee a product will be held for them to purchase as the product becomes available. In one embodiment, the system allows for updates to be sent to the user device regarding the status of their reserved product and order. FIG. 7 depicts an embodiment of FIG. 8, wherein a user defines 512 within the application a the desired device should be sent, such as to the retail location itself or to another address for pick-up and an alert is sent 513 to the user device to inform the user as to the location of the product.

While the present invention has been particularly described, it is evident that many alternatives, modifications and variations will be apparent to those skilled in the art in light of the foregoing description. It is therefore contemplated that the appended claims will embrace any such alternatives, modifications, and variations as falling within the true scope and spirit of the present invention.

What is claimed is:

1. A system for allowing a user to interact with an inventory of a retail location comprising:
a. A computer;
b. An inventory information database, said inventory information database having inventory information comprising at least one characteristic of at least one product sold at said retail location;
c. Software executing on said computer for, based upon input from said computer, producing at least a first set of said at least one product to the user, wherein said at least one product in said at least a first set have at least a first number of shared characteristics;
d. Software executing on said computer for, based upon input from said computer, producing at least a second set of said at least one product to the user, wherein the products in said at least a second set have at least a second number of shared characteristics shared, wherein said second set is a subset of said first set;
e. Wherein said second number of shared characteristics is greater than or equal to said first number of shared characteristics and said first number of shared characteristics is greater than said third number of shared characteristics,

2. The system of claim 1 further comprising software executing on said computer for, based upon input from said computer, producing a recommended product to the user, wherein said recommended product has at least a third number of shared characteristics shared with a product in said first set.

3. The system of claim 1 further comprising software executing on said computer for purchasing at least one product.

4. The system of claim 1 further comprising software executing on said computer for reserving at least one product.

5. The system of claim 4, wherein said software executing on said computer for reserving at least one product further sends an alert to said computer indicating a location of said at least one product.

6. The system of claim 1 further comprising software executing on said computer for performing an inspection action.

7. The system of claim 5, wherein said inspection action is an alert sent to an employee of the retail location indicating said inventory information about a product.

8. The system of claim 6, wherein said alert further comprises location information of said computer,

9. The system of claim 1 further comprising:
a. Software executing on said computer for accessing said database;
b. Software executing on said computer for sorting said inventory information

10. A method for allowing a user to interact with an inventory of a retail location comprising the steps of:
a. Providing a computer;
b. Placing an inventory information database on said computer, said inventory information database having inventory information comprising at least one entry defining at least one characteristic of at least one product sold at said retail location;
c. Placing an application in communication with said inventory information database;
d. Generating at least a first set of said at least one product based on input from said user, wherein said at least one product in said at least a first set have at least a first number of shared characteristics;
e. Generating at least a first subset of said at least one product based on input from said user, wherein the products in said at least a first subset set have at least a second number of shared characteristics, said second number of shared characteristics being greater than or equal to said first number of shared characteristics;
f. Generating at least a first recommended product based on input from said user and having at least a third number of shared characteristics less than said first number of shared characteristics with said first product;

11. The method of claim 10 further comprising the step of performing a selection action to inspect a selected product.

12. The method of claim 10 further comprising the step of performing a purchasing action to purchase a selected product.

13. The method of claim 12, wherein said step of performing a purchasing action further comprises the step of performing a reservation action.

14. The method of claim 13, wherein said step of performing a reservation action comprises the step of providing said user a choice of holding said selected product at said retail location for retrieval by said user or shipping said selected product to another location.

15. The method of claim 14, further comprising the step of sending an alert to said user indicating a location of said selected product.

16. The method of claim 10 further comprising the step of performing an inspection action.

17. The method of claim 16, wherein said step of performing an inspection action further comprises the step of sending an alert sent to an employee of the retail location comprising said inventory information about a product.

18. The method of claim 17, wherein said step of sending an alert further comprises sending an alert to an employee comprising location information about said user,

19. The method of claim 10 further comprising the step of sorting said inventory information using said application.

20. A system for allowing a user to interact with an inventory of a retail location comprising:
a. At least one system of a retail location comprising an inventory information database, wherein said inventory information comprises at least one characteristic of at least one product sold at said retail location;
b. An input device;
c. A viewing device.
d. An application on said input device capable of interacting with said inventory information;
e. At least a first set of said at least one product displayed on said viewing device in response to at least a first input to said input device sharing at least a first number of characteristics;
f. At least a second set of said at least one product displayed on said viewing device in response to at least a second input to said input device sharing at least a second number of characteristics, where said second set of said at least one product is a subset of said first set;
g. A recommended product displayed on said viewing device in response to said first or second inputs to said input device sharing at least a third number of characteristics with said first set;
wherein said second number of shared characteristics is greater than said first number of shared characteristics and said first number of shared characteristics is greater than said third number of shared characteristics.
